(19) United States
(12) Patent Application Publication
(10) Pub. No.: US 2026/0141248 A1
(43) Pub. Date: May 21, 2026

(54) SYSTEMS AND METHODS FOR PREFERENCE ALIGNMENT USING PARTIALLY OBSERVED PREFERENCE CHOICES

(71) Applicant: Salesforce, Inc., San Francisco, CA (US)

(72) Inventors: Govardana Sachithanandam Ramachandran, Palo Alto, CA (US); Yingbo Zhou, Palo Alto, CA (US); Caiming Xiong, Menlo Park, CA (US)

(21) Appl. No.: 18/954,908

(22) Filed: Nov. 21, 2024

(51) Int. Cl. G06N 3/09; G06F 40/274; G06F 40/40; G06N 3/0475

(52) U.S. Cl. CPC G06N 3/09; G06F 40/274; G06F 40/40; G06N 3/0475

(57) ABSTRACT

Embodiments described herein provide an LLM training framework that utilizes imperfect human labeled training data. In the context of text auto-complete for code, users are provided auto-complete text that they may explicitly accept or reject, or implicitly reject by continuing to type. This results in binary (yes/no) data that is “partially observed” by the fact that implicit rejections may not be true rejections. The probability of a specific output being accepted may be predicted based on the probability of the current model prediction according the model itself, and a “threshold” value generated by a trainable model. For a given predicted auto-complete output, a loss may be computed based on how the predicted probability aligns with the actual user selection (rejection/acceptance). The loss may be modified by a loss shaping function as illustrated here to compensate for the “imperfect” human labeling.

### TECHNICAL FIELD

The embodiments relate generally to machine learning systems for text generation, and more specifically to preference alignment using partially observed preference choices.

### BACKGROUND

AI conversation agents, commonly known as chatbots or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI conversation agents can assist with product recommendations, order tracking, and personalized shopping experiences. In information technology (IT) support, these agents can guide users through troubleshooting steps, helping them resolve software and hardware issues. Specifically, for network hazards, AI conversation agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

Large language models (LLMs) have wide applications in different technical fields, such as healthcare, IT support, code generation, and/or the like. An LLM may be used, for example, in generating executable code. For example, a large language model (LLM) may be provided an input prompt from a user, and the LLM may generate code in response to the prompt. Users may have varying preference, however, with regard to the utilization of generated code. After an initial training phase on broad training data, fine-tuning of the LLM may be performed such as reinforcement learning via human feedback (RLHF) in order to improve alignment between model outputs and human preference (i.e., “preference alignment”). In existing preference alignment methods, human preference data is in the form of human scored (e.g., 1-10) outputs, or human-ranked outputs (e.g., ranking of 2 or more responses). This type of training data, however, is costly to acquire in that it requires a lot of manual scoring of training data. Therefore, there is a need for improved methods for training code generation models.

### BRIEF DESCRIPTION OF THE DRAWINGS

FIG. 1 is a simplified diagram illustrating a user interface according to some embodiments.

FIG. 2 is a simplified diagram illustrating a code generation framework according to some embodiments.

FIG. 3 illustrates a shaped loss function according to some embodiments.

FIG. 4A illustrates a joint probability model according to some embodiments.

FIG. 4B illustrates a joint probability model according to some embodiments.

FIG. 5A is a simplified diagram illustrating a computing device implementing the code generation framework described in FIGS. 1-4B, according to some embodiments.

FIG. 5B is a simplified diagram illustrating a neural network structure, according to some embodiments.

FIG. 6 is a simplified block diagram of a networked system suitable for implementing the code generation framework described in FIGS. 1-5B and other embodiments described herein.

FIG. 7 is an example logic flow diagram illustrating a method of training a neural network based language model based on the framework shown in FIGS. 1-6, according to some embodiments.

FIGS. 8-11 provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

### Overview

Large language models (LLMs) have wide applications in different technical fields, such as healthcare, IT support, code generation, and/or the like. An LLM may be used, for example, in generating executable code. For example, a large language model (LLM) may be provided an input prompt from a user, and the LLM may generate code in response to the prompt. Users may have varying preference, however, with regard to the utilization of generated code. After an initial training phase on broad training data, fine-tuning of the LLM may be performed such as reinforcement learning via human feedback (RLHF) in order to improve alignment between model outputs and human preference (i.e., “preference alignment”). In existing preference alignment methods, human preference data is in the form of human scored (e.g., 1-10) outputs, or human-ranked outputs (e.g., ranking of 2 or more responses). This type of training data, however, is costly to acquire in that it requires a lot of manual scoring of training data.

In view of the need for improved methods for training code generation models, embodiments described herein provide a systems and methods for preference alignment using imperfect human labeled training data such as partially observed preference choices. Specifically, in the context of text auto-complete, users are provided auto-complete text that they may explicitly accept or reject, or implicitly reject by continuing to type. This results in binary (yes/no) data that is “partially observed” by the fact that implicit rejections may not be true rejections. Therefore, such “imperfect” human labels may be transformed into loss computation during training.

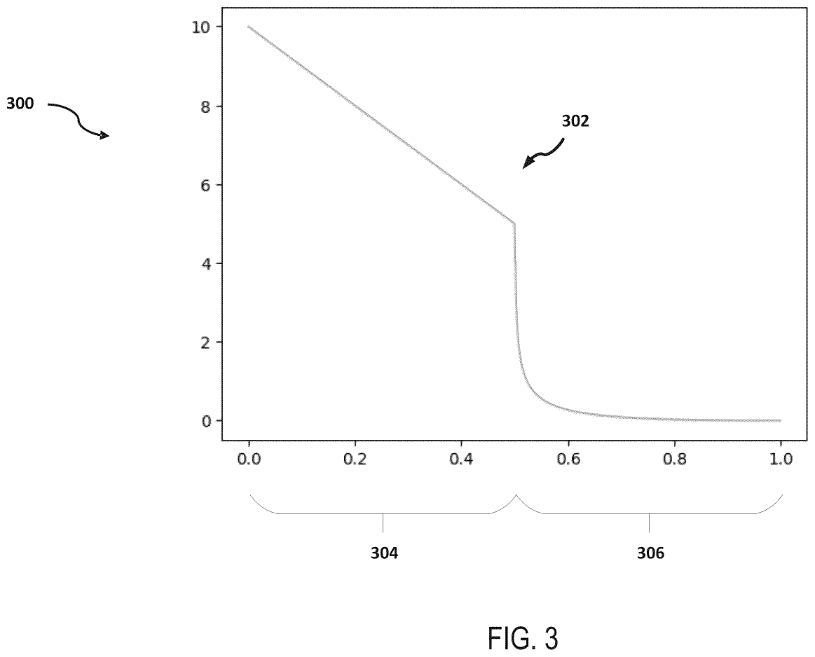

The probability of a specific output being accepted may be predicted based on the probability of the current model prediction according the model itself, and a threshold value generated by a trainable threshold model. The threshold model effectively represents the threshold of accuracy of an output over which a user is likely to accept the output. For a given predicted auto-complete output, a loss may be computed based on how the predicted probability aligns with the actual user selection (rejection/acceptance). The loss may be modified by a loss shaping function as illustrated in FIG. 3 to compensate for the “imperfect” human labeling.

In some embodiments, the loss shaping function reflects the specific input data, specifically that the user acceptance/rejection is a binary choice. Fine-grained data indicating the likelihood of acceptance over the 50% point is not available, so a prediction above that level does not hold as much information. For example, for an output that is accepted by a user, if the prediction that it would be accepted is below 0.5 (50%), the gradient is monotonically decreasing. A steep drop in the loss is provided when the prediction is above 0.5, with a slight decline as the prediction increases. This loss shaping function accurately models the input data, as an acceptance by a user is binary, so a prediction over 50% is the strongest signal with less importance on the strength of the prediction. The LLM and the threshold model may be jointly trained according to the shaped loss. Subsequent code generation may be performed using the trained model.

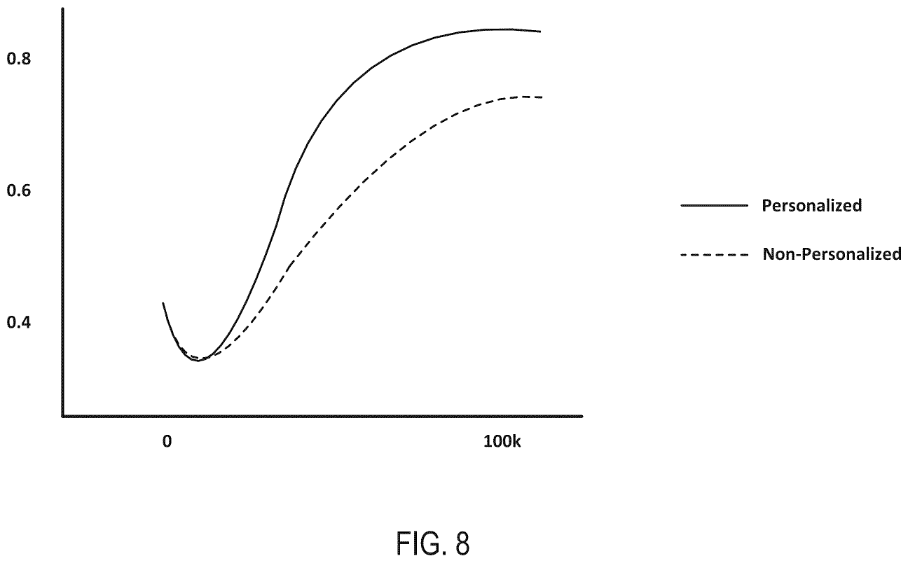

Embodiments described herein provide a number of benefits. For example, the preference alignment method described herein allows for naturally labeled data (e.g., accept/decline signals) rather than manually scored data. As illustrated in FIGS. 8-11, the performance of the model on different metrics is improved over baseline models. User-specific tailoring is also made possible by using the data that is generated during regular use of the code generation auto-complete functionality. Therefore, with improved performance on code generation, neural network technology in large language models, personalization, model training, text generation, etc. is improved.

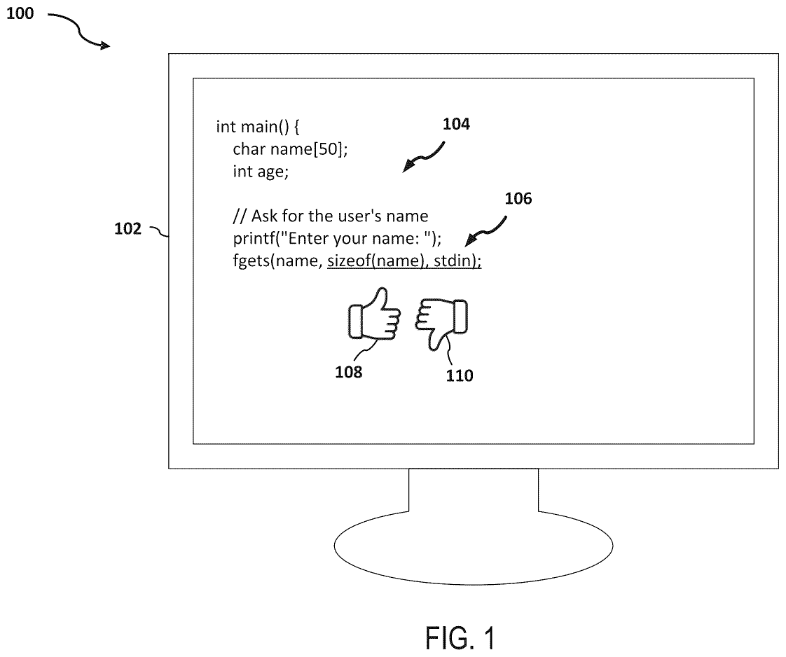

FIG. 1 is a simplified diagram illustrating a user interface 100 according to some embodiments. The user interface 100 may be configured to allow a user to type executable code (e.g., code written in a programming language such as c, c++, python, javascript, etc.). User interface 100 may be displayed via a user device 102 (e.g., a computer monitor, a portable device, etc.) The user interface may be, for example, a programming environment that allows for compiling, debugging, and/or executing written code. In the illustrated example, the user has entered code 104 which includes a few lines of code and a comment, and a partial line of code. The system has inserted code 106 as an auto-completion of the last line of code (indicated via an underline). User interface 100 may allow a user to explicitly accept or reject the auto-completed code 106 via acceptance selector 108 or rejection selector 110. In some embodiments, a user may also reject auto-completed code 106 by continuing to type, implicitly rejecting the auto-completed code 106.

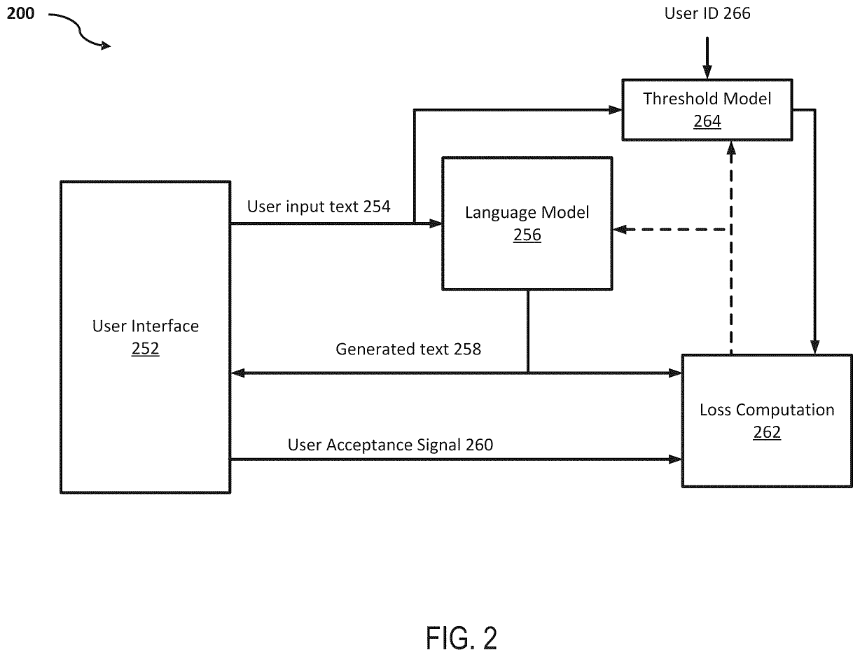

FIG. 2 is a simplified diagram illustrating a code generation framework 200 according to some embodiments. Framework 200 includes user interface 252, which may be a user interface 100 according to some embodiments. A user may enter text (e.g., code) and user interface 252 may display generated text (e.g., code). User input text 254 may be input to a language model 256 (e.g., a neural network based language model) which may in response generate generated text 258. In some embodiments, generated text 258 is generated by language model 256 further based on a system prompt that indicates certain information to language model 256. For example, the system prompt may give information about syntax, programming language, styles, type of code preferred, preferred format for generated text 258, among others. Generated text 258 may be displayed via user interface 252, and may also be used in computing a loss function for training language model 256.

User interface 252 may also allow a user to indicate a user acceptance signal 260. User acceptance signal 260 may indicate, for example, an explicit acceptance of generated text 258, an explicit rejection of generated text 258, or an implicit rejection of generated text 258 as described in FIG. 1. User acceptance signal 260 may also be used in computing a loss function for training language model 256.

Loss computation 262 may compute a loss function based on the context (e.g., user input text 254), generated text 258 (or the probability associated with generated text 258), and user acceptance signal 260. The computed loss may be used to update parameters of language model 256, for example via backpropagation. In some embodiments, the context includes identification of a user, an instance, information about the programming language, an indicated goal of the code, etc.

Training of language model 256 may be performed over multiple stages. For example, an initial training phased may be performed followed by a fine-tuning phase and/or an alignment phase. An alignment training phase may be performed to align the generated outputs to a certain type of response, to align with preferences in a certain context, etc. In the case of code generation, alignment may be performed to align the generated text with generations that are more likely to be accepted by a (specific) user. One method for aligning language model 256 with human preference is a Bradly-Terry framework which frames the preference between a pair of choices as Bernoulli distribution given a dataset of pairs of human preferences. For example, given an input prompt x, and a pair of responses (y_{w},yₗ) where y_{w} and yₗ are winning and losing responses respectively (e.g., preferred and non-preferred), preference may be computed as:

$$P ( {y}_{1} ≻ {y}_{2} \vert x ) = \frac{1}{1 + exp ( {r}^{*} ( x , {y}_{w} ) - {r}^{*} ( x , {y}_{l} )} \qquad ( 1 )$$

In equation (1), the input prompt (e.g., the typed code before an auto-complete) is represented as x, and the different outputs are represented as y₁ and y₂. Note that this formulation requires different output options, which may not be available such as in the situation described in FIG. 1 where a user is provided a single option and the ability to accept or reject. A latent reward rₚ(x,y) may be learned by optimizing equation (1) using the following binary cross entropy loss:

$$L = {x , {y}_{w} , {y}_{l} ∼ D}_{} [ - log \frac{1}{1 + exp ( {r}_{p} ( x , {y}_{w} ) - {r}_{p} ( x , {y}_{l} ) )} ]$$

In order to avoid catastrophic forgetting, a preference based reward rₚ(x,y) may be reshaped with a KL-divergence penalty between the reinforcement learning and supervised fine-tuning policies. This is to ensure the preference tuned policy doesn't stray too far away from the fine-tuned model's state-action space. Especially for state-action spaces where the support of the preference labels does not cover. A reward may be reshaped, for example, as follows:

$${r}_{s} ( x , y ) = {r}_{p} ( x , y ) - β {D}_{KL} ( {π}_{t} ( y \vert x ) \vert \vert {π}_{b} ( y \vert x ) )$$

In this equation, πₜ represents the policy being learned and π_{b} represents a baseline policy. rₚ is the reward based on the preference. A policy may be optimized for maximizing the above reward as follows:

$${π}_{t} = arg {max}_{π} {x ∼ D , y ∼ π}_{} [ {r}_{s} ( x , y ) ]$$

This may be reparametrized into the following closed form:

$${π}_{t} = \frac{1}{Z ( x )} {π}_{b} ( y \vert x ) exp ( \frac{1}{β} {r}_{p} ( x , y ) ) \qquad ( 2 )$$

Here, the partition function is of the form

$$z ( x ) = {\sum }_{y} {π}_{b} ( y \vert x ) exp ( {r}_{p} ( x , y ) / β ) .$$

The above expression can be rearranged for the preference reward rₚ(x,y) as:

$${r}_{p} ( x , y ) = β log \frac{{π}_{t} ( y \vert x )}{{π}_{b} ( y \vert x )} + β log Z ( x ) \qquad ( 3 )$$

The loss computation may be performed based on an assumption that there exists an underlying reward threshold rₐ(x) over which a user will accept a certain generated text. A Bradley-Terry objective may be constructed using the reward threshold rₐ(x) to compare the preference reward of the response rₚ(x,y). The probability of acceptance of a response y for a goal x may be defined as:

$$P ( a \vert y , x ) = \frac{1}{1 + exp - ( {r}_{p} ( x , y ) - {r}_{a} ( x ) )}$$

Using the closed form expression for equation (3) for preference reward rp(x,y) in the above equation this may be represented as:

$$P ( a \vert y , x ) = \frac{1}{\begin{matrix}1 + exp - ( β log \frac{{π}_{t} ( y \vert x )}{{π}_{b} ( y \vert x )} + \\ β {\sum }_{{y}^{′}} {π}_{b} ( y \vert x ) exp ( \frac{{r}_{p} ( x , {y}^{′} )}{β} ) - {r}_{a} ( x ) )\end{matrix}} \qquad ( 4 )$$

Here, both the partition function

$$Z ( x ) = {\sum }_{{y}^{′}} {π}_{b} ( y \vert x ) exp ( {r}_{p} ( x , {y}^{′} ) / β )$$

and the reward threshold, rₐ(x) are only functions of the x and not y. These may be combined into a single function η(x) that may be learned, where η(x) represents Z(x)−rₐ(x)/β. With this substitution, the probability of acceptance becomes:

$$P ( a \vert y , x ) = \frac{1}{1 + exp - ( β log \frac{{π}_{t} ( y \vert x )}{{π}_{b} ( y \vert x )} - βη ( x ) )} \qquad ( 5 )$$

Equation (5) represents the probability of a user accepting output y for a context x. Note that equation (5) only requires a single output (y) corresponding to an input (x), rather than two outputs as in equation (1). Effectively, rather than comparing different outputs, the single output is compared to a threshold value representing the user's preference threshold. πₜ(y|x) may be understood to represent the probability of the language model being trained predicting the output y for an input x. Likewise, π_{b}(y|x) may be understood to represent the probability of the baseline language model (e.g., a fixed version of the language model) predicting the output y for an input x. η(x) may be understood to represent the threshold model 264, defining the probability that a user will accept a generated response based on the input x. The threshold model 264 may be learned as part of the training process. For example, the threshold model 264 may be jointly trained with language model 256 according to the loss described below (e.g., equation (7)). In some embodiments, a user identification 266 is appended or otherwise included in input x, such that the threshold function (which is a function of input x) may adjust the threshold according to the specific user. An alternative perspective for equation (5), is as follows: If the preference reward is parameterized as as β log(πᵣ(x; θ))/(π_{b}(x)). Then substituting this parametrization of rₚ(aₜ,sₜ) to equation (3) results in:

$${π}_{t} = \frac{{π}_{r} ( y \vert x ; θ )}{Z ( x )}$$

Then πₜ=πᵣ(y|x; θ), since Z(x)=Σ_{y′}πᵣ(y|x; θ)=1. Therefore optimizing for equation (5) is equivalent to optimizing for equation (4). As y represents the entire response and y is composed of a series of tokens at, i.e., y=(a₁, . . . , a_{T}), the reward parameterization of a response y may be decomposed as:

$${r}_{p} ( x , y ) = log \frac{{π}_{r} ( y \vert x ; θ )}{{π}_{b} ( y \vert x )} = \frac{1}{\vert y \vert} {\sum }_{{a}_{t} ∈ y} log \frac{{π}_{t} ( {a}_{t} \vert {a}_{< t} , x ; θ )}{{π}_{b} ( {a}_{t} \vert {a}_{< t} , x )}$$

Here |y| is the length of the response. Hence the token level formulation of equation (5) is as follows:

$$P ( y ≻ a \vert x ) = P ( a \vert y , x ) = \frac{1}{1 + exp - ( β \frac{1}{\vert y \vert} {\sum }_{{a}_{t} ∈ y} log \frac{{π}_{t} ( {a}_{t} \vert {a}_{< t} , x ; θ )}{{π}_{b} ( {a}_{t} \vert {a}_{< t} , x )} - βη ( x ) )} \qquad ( 6 )$$

With this probabilistic formulation, the maximum likelihood estimate of the reward function may be obtained by optimizing the cost function. When the user makes a choice to either accept or reject a response, the only information in user acceptance signal 260 is that the utility (read as reward) of the response is above an underlying threshold. The user neither emits the cardinality of the choice (e.g., how much better or worse a response is relative to the threshold), nor the user emits the ordinality of the choice (e.g., relative ordering of the choices). Given this, the cost function matching the process of acceptance can be expressed by the form:

$$Let q = {p ( a \vert y , x )}^{a} {( 1 - p ( a \vert y , x ) )}^{( 1 - a )}$$

then the true unbiased objective (cost function) can be expressed as:

$${L}_{unbiased} = {x , y ∼ D}_{} I ( q < 0.5 )$$

where a is the label (e.g., 0 or 1) representing whether a user accepted the output y or not, and p is the computed probability of the user accepting the text (e.g., according to equation (5)). If a user accepted the response such that a=1, then q is the probability of accepting response y for given prompt/context x (e.g., according to equation (5)). If the user did not accept the response such that a=0, then q is that probability of rejecting response y for given prompt/context x from 1.

The true unbiased cost function L_{unbiased} takes the shape of a step function. This is because when the condition q<0.5 is satisfied L_{unbiased}=1 and q<0.5 is not satisfied L_{unbiased}=0. However, such a function does not have a gradient and is not differentiable, so it is not useful as a reward for training language model 256. Therefore, the loss may be shaped to a more useful reward.

FIG. 3 illustrates a shaped loss function according to some embodiments. In FIG. 3, the x axis is q as described above, and this value is mapped according to a cost on the y axis. The scale of the y axis is arbitrary as it is scaled by a learning rate parameter during training. The shaped loss function includes two regions. In region 304, the generated output text is “misaligned” meaning that the prediction of user acceptance is different than the actual acceptance (e.g., the predicted probability of user acceptance is above 50%, but the user did not accept). In region 306, the output is “aligned,” meaning that the prediction of user acceptance is aligned with the actual acceptance (e.g., the predicted probability of user acceptance is above 50%, and the user did accept). These may be referred to as a region of misalignment (RoM) and region of alignment (RoA). A generated response is not assumed to need to be optimal, but rather just above a threshold. Ideally no optimization is needed in the region of alignment. At the same time, it is preferable to increase the probability of acceptance so that some other change in the system or data may induce a rejection. For this reason, a smooth monotonically decreasing function may be used that has a sharper gradient near the decision boundary and near zero everywhere else. The sharper gradient near the decision boundary helps improve the margin near the decision boundary. There is no cardinal information in the misalignment region either, hence a loss surface may be selected that has a constant gradient as shown in FIG. 3. These losses may be represented as:

$${L}_{RoA} = log 2 {( q - ( 0.5 + ϵ ) )}^{ρ} + \frac{0.5}{log ( ϵ )}$$

$${L}_{RoM} = 1 - q$$

where L_{RoA} represents the loss in the region of alignment (e.g., region 306) and L_{RoM} represents the loss in the region of misalignment (e.g., region 304). Further, e is a small positive value. The parameter ρ∈2Z (i.e., an even integer) which helps in the strength of maximizing the margin past the threshold. The total loss may be represented as:

$$L = I ( q > 0.5 ) {L}_{RoM} + I ( q < 0.5 ) {L}_{RoA} \qquad ( 7 )$$

Language model 256 may be trained according to loss function (7). In some embodiments, language model 256 is jointly trained with a threshold model as described above. Batches of training data may be compiled over time including multiple contexts with associated predictions and user acceptance labels, and these may be used as a batch to train the language model 256 together with the threshold model.

Effectively, in some embodiments, loss computation 262 computes a loss as a function of the context (e.g., user input text 254, a system prompt, etc.), generated text 258 (or the probability of language model 256 generating generated text 258), and the user acceptance signal 260. Loss computation 262 may be further based on a predicted threshold value. The predicted threshold value may be computed by threshold model 264 based on the context (e.g., user input text 254 and any system prompt). In some embodiments, the context is represented as x in the equations above. In some embodiments, threshold model 264 is represented by η(x) in the equations above. In some embodiments, generated text 258 is represented by y in the equations above. In some embodiments, the probability of language model 256 predicting generated text 258 is represented by πₜ(y|x) in the equations above. In some embodiments, the probability of a baseline language model (e.g., a non-aligned language model with the same starting parameters as language model 256) predicting generated text 258 is represented by π_{b}(y|x) in the equations above. In some embodiments, user acceptance signal 260 is represented by a in the equations above.

In some embodiments, loss computation 262 computes a predicted probability of a code completion (e.g., generated text 258) for a user-entered executable code (e.g., user input text 254) based on a context including the user-entered executable code. In some embodiments, this probability is computed by language model 256 and provided to loss computation 262 (e.g., πₜ(y|x)). In some embodiments, threshold model 264 generates an acceptance threshold value deciding whether a model-generated code is to be accepted by a user based on the context. In some embodiments, loss computation 262 generates a prediction of user acceptance of the code completion based on a comparison involving the predicted probability of the code completion and the acceptance threshold value (e.g., according to equation (5)). In some embodiments, loss computation 262 computes a loss based on a comparison of the prediction of user acceptance and the actual user acceptance or rejection (e.g., user acceptance signal 260), and a predefined loss shaping function (e.g., as illustrated in FIG. 3) that scales the comparison.

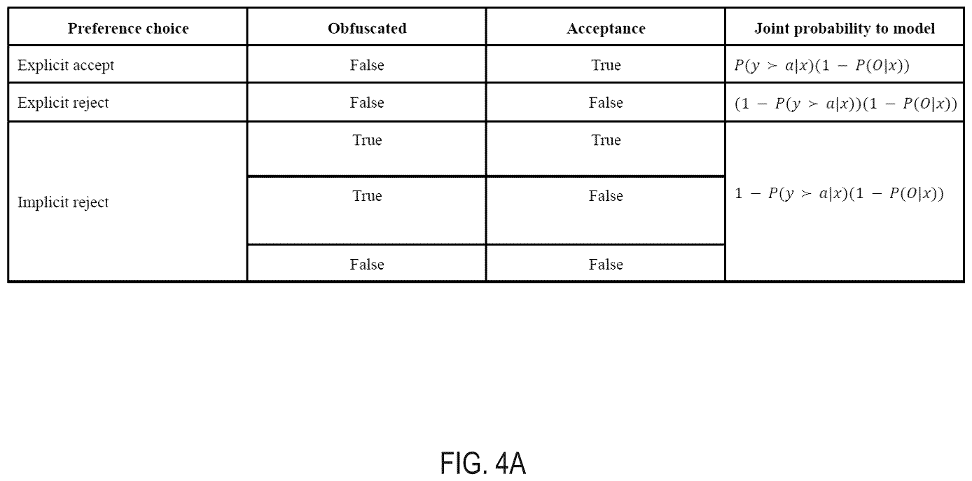

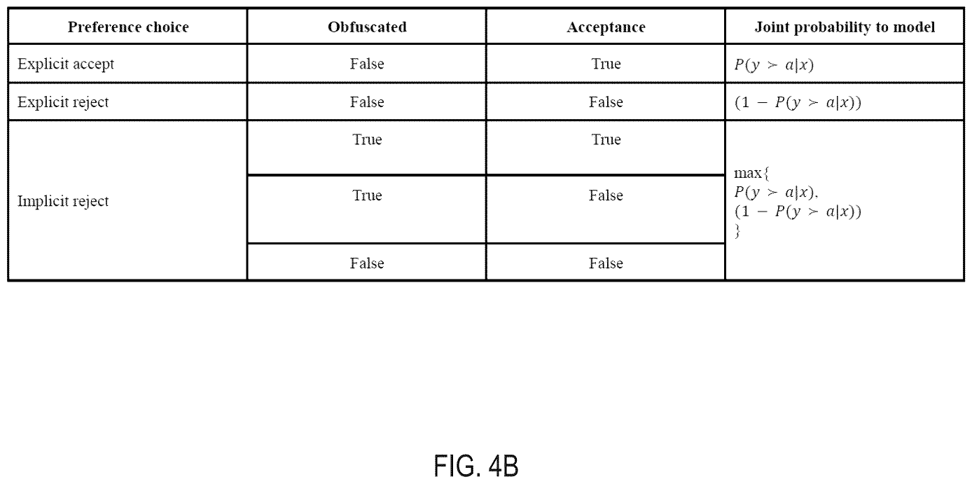

FIG. 4A illustrates a joint probability model according to some embodiments. Implicit rejections (e.g., continuing to type rather than explicitly selecting to reject an auto-complete) in practice makes up the vast majority of the preference data collected from a code auto-complete service. Implicit rejection may be because the user didn't pay attention or the user wasn't expecting a recommendation or the recommended response was not correct for the context. Though it is unclear the true preference label of implicit rejection, there is still value in using this data. This may be treated as a Blind Source Separation (BSS) problem, BSS are a class of problems that entails two or more source signals mixed and the objective is to separate these mixed signals. A classical example of BSS is the “cocktail party problem”—the problem of isolating individual speakers' voice in a cocktail party with a lot of background chatter. Here it may be assumed the preference choices observed are a mix of signals from two sources. Source #1 is the user's actual preference for a recommendation, which is modeled as—the probability of acceptance P(a|y,x) and Source #2, is attributed to other factor such as: the user did not pay attention or the user wasn't expecting a recommendation etc., which is modeled as P(O|x)—probability of obfuscation. This combined objective may be optimized.

The preference choices and their joint probability to optimize is described in FIG. 4A. There are three inputs for the obfuscation model P(O|x). First, the context/prompt, which is used for the recommendation for cases when a recommendation is not needed for a specific context. Second, User-Id or user related information, which is to capture a user's predisposition when a recommendation is expected. Third, an instance-id for each data point, which is for other exogenous factors which are specific for a data point can not be explained by user or contextual information. In some embodiments, the model may be allowed to overfit on the instance-id.

FIG. 4B illustrates a joint probability model according to some embodiments. If the obfuscation (i.e., implicit rejects) in the data are predominantly independent of input x (i.e., P(O|x)=P(O)), optimizing the proposed cost function may be done using the joint probability model defined in FIG. 4B. This method entails reduction of the entropy of the model prediction if labels are unavailable (i.e., implicit reject).

### Computer and Network Environment

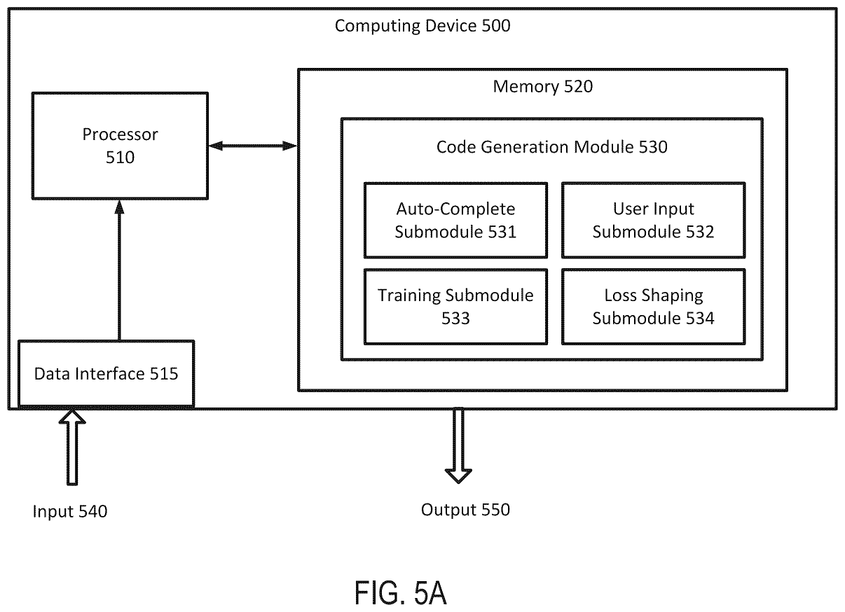

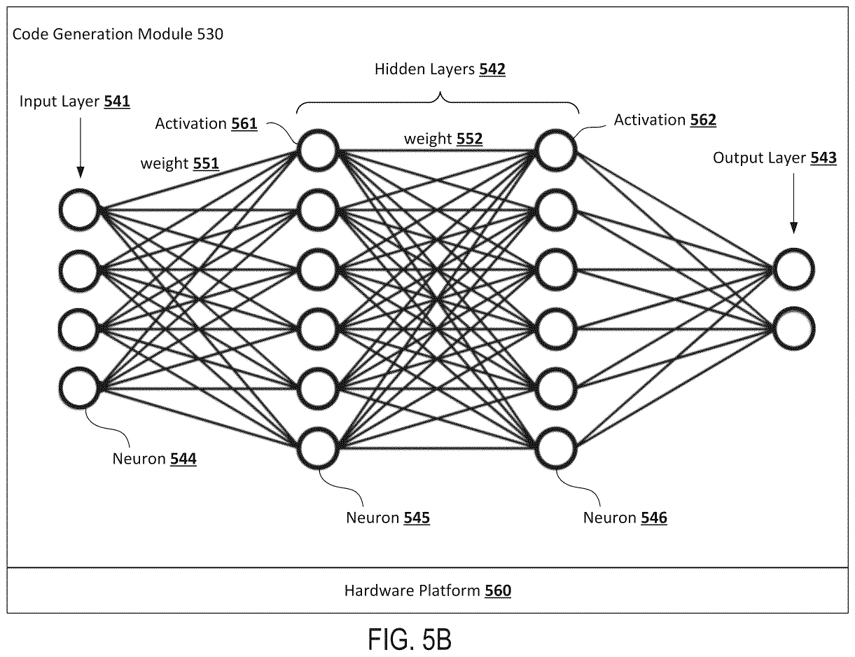

FIG. 5A is a simplified diagram illustrating a computing device implementing the code generation framework described in FIGS. 1-4B, according to one embodiment described herein. As shown in FIG. 5A, computing device 500 includes a processor 510 coupled to memory 520. Operation of computing device 500 is controlled by processor 510. And although computing device 500 is shown with only one processor 510, it is understood that processor 510 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 500. Computing device 500 may be implemented as a stand-alone subsystem, as a board added to a computing device, and/or as a virtual machine.

Memory 520 may be used to store software executed by computing device 500 and/or one or more data structures used during operation of computing device 500. Memory 520 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 510 and/or memory 520 may be arranged in any suitable physical arrangement. In some embodiments, processor 510 and/or memory 520 may be implemented on a same board, in a same package (e.g., system-in-package), on a same chip (e.g., system-on-chip), and/or the like. In some embodiments, processor 510 and/or memory 520 may include distributed, virtualized, and/or containerized computing resources. Consistent with such embodiments, processor 510 and/or memory 520 may be located in one or more data centers and/or cloud computing facilities.

In another embodiment, processor 510 may comprise multiple microprocessors and/or memory 520 may comprise multiple registers and/or other memory elements such that processor 510 and/or memory 520 may be arranged in the form of a hardware-based neural network, as further described in FIG. 5B.

In some examples, memory 520 may include non-transitory, tangible, machine readable media that includes executable code that when run by one or more processors (e.g., processor 510) may cause the one or more processors to perform the methods described in further detail herein. For example, as shown, memory 520 includes instructions for code generation module 530 that may be used to implement and/or emulate the systems and models, and/or to implement any of the methods described further herein. code generation module 530 may receive input 540 such as an input training data (e.g., generated code, acceptance and rejection indicators, etc.) via the data interface 515 and generate an output 550 which may be generated code.

The data interface 515 may comprise a communication interface, a user interface (such as a voice input interface, a graphical user interface, and/or the like). For example, the computing device 500 may receive the input 540 (such as a training dataset) from a networked database via a communication interface. Or the computing device 500 may receive the input 540, such as code input, from a user via the user interface.

In some embodiments, the code generation module 530 is configured to generate code, including training and/or fine-tuning the code generation model (e.g., LLM). The code generation module 530 may further include auto-complete submodule 531 configured to generate auto-complete code text based on an input code text and display the generated code via a user interface according to embodiments described herein. The code generation module 530 may further include user input submodule 532 configured to receive user input including typed code, acceptance, and rejection indications of associated with generated code according to embodiments described herein. The code generation module 530 may further include training submodule 533 configured to train the neural network based language model according to embodiments described herein. The code generation module 530 may further include loss shaping submodule 534 configured to modify the loss computed for training according to embodiments described herein.

Some examples of computing devices, such as computing device 500 may include non-transitory, tangible, machine readable media that include executable code that when run by one or more processors (e.g., processor 510) may cause the one or more processors to perform the processes of the methods described herein. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 5B is a simplified diagram illustrating the neural network structure implementing the code generation module 530 described in FIG. 5A, according to some embodiments. In some embodiments, the code generation module 530 and/or one or more of its submodules 531-534 may be implemented at least partially via an artificial neural network structure shown in FIG. 5B. The neural network comprises a computing system that is built on a collection of connected units or nodes, referred to as neurons (e.g., 544, 545, 546). Neurons are often connected by edges, and an adjustable weight (e.g., 551, 552) is often associated with the edge. The neurons are often aggregated into layers such that different layers may perform different transformations on the respective input and output transformed input data onto the next layer.

For example, the neural network architecture may comprise an input layer 541, one or more hidden layers 542 and an output layer 543. Each layer may comprise a plurality of neurons, and neurons between layers are interconnected according to a specific topology of the neural network topology. The input layer 541 receives the input data (e.g., 540 in FIG. 5A), such as input text (e.g., executable code). The number of nodes (neurons) in the input layer 541 may be determined by the dimensionality of the input data (e.g., the length of a vector of the input text). Each node in the input layer represents a feature or attribute of the input.

The hidden layers 542 are intermediate layers between the input and output layers of a neural network. It is noted that two hidden layers 542 are shown in FIG. 5B for illustrative purpose only, and any number of hidden layers may be utilized in a neural network structure. Hidden layers 542 may extract and transform the input data through a series of weighted computations and activation functions.

For example, as discussed in FIG. 5A, the code generation module 530 receives an input 540 of code text and transforms the input into an output 550 of additional code text (e.g., an auto-complete of the input code text). To perform the transformation, each neuron receives input signals, performs a weighted sum of the inputs according to weights assigned to each connection (e.g., 551, 552), and then applies an activation function (e.g., 561, 562, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 541 is transformed into rather different values indicative data characteristics corresponding to a task that the neural network structure has been designed to perform.

The output layer 543 is the final layer of the neural network structure. It produces the network's output or prediction based on the computations performed in the preceding layers (e.g., 541, 542). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the code generation module 530 and/or one or more of its submodules 531-534 may comprise the transformative neural network structure of layers of neurons, and weights and activation functions describing the non-linear transformation at each neuron. Such a neural network structure is often implemented on one or more hardware processors 510, such as a graphics processing unit (GPU).

In one embodiment, the code generation module 530 and its submodules 531-534 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

In one embodiment, the code generation module 530 and its submodules 531-534 may be implemented by hardware, software and/or a combination thereof. For example, the code generation module 530 and its submodules 531-534 may comprise a specific neural network structure implemented and run on various hardware platforms 560, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 560 used to implement the neural network structure is specifically configured based on factors such as the complexity of the neural network, the scale of the tasks (e.g., training time, input data scale, size of training dataset, etc.), and the desired performance.

In another embodiment, some or all of layers 541, 542, 543 and/or neurons 542, 545, 546, and operations there between such as activations 561, 562, and/or the like, of the code generation module 530 and its submodules 531-534 may be realized via one or more ASICs. For example, each neuron 542, 545 and 546 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the code generation module 530 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based code generation module 530 and one or more of its submodules 531-534 may be trained by iteratively updating the underlying parameters (e.g., weights 551, 552, etc., bias parameters and/or coefficients in the activation functions 561, 562 associated with neurons) of the neural network based on the loss described in relation to FIGS. 1-4B. For example, during forward propagation, the training data such as generated code and user selections are fed into the neural network. The data flows through the network's layers 541, 542, with each layer performing computations based on its weights, biases, and activation functions until the output layer 543 produces the network's output 550. In some embodiments, output layer 543 produces an intermediate output on which the network's output 550 is based.

The output generated by the output layer 543 is compared to the expected output (e.g., a “ground-truth” such as the corresponding give an example of ground truth label) from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the last layer 543 to the input layer 541 of the neural network. These gradients quantify the sensitivity of the network's output to changes in the parameters. The chain rule of calculus is applied to efficiently calculate these gradients by propagating the gradients backward from the output layer 543 to the input layer 541.

In one embodiment, the neural network based code generation module 530 and one or more of its submodules 531-534 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

In one embodiment, code generation module 530 and its submodules 531-534 may be housed at a centralized server (e.g., computing device 500) or one or more distributed servers. For example, one or more of code generation module 530 and its submodules 531-534 may be housed at external server(s). The different modules may be communicatively coupled by building one or more connections through application programming interfaces (APIs) for each respective module. Additional network environment for the distributed servers hosting different modules and/or submodules may be discussed in FIG. 4.

During a backward pass, parameters of the neural network are updated backwardly from the last layer to the input layer (backpropagating) based on the computed negative gradient using an optimization algorithm to minimize the loss. The backpropagation from the last layer 543 to the input layer 541 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as generating auto-complete code text.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in text prediction, code generation, language model training, user preference alignment, etc.

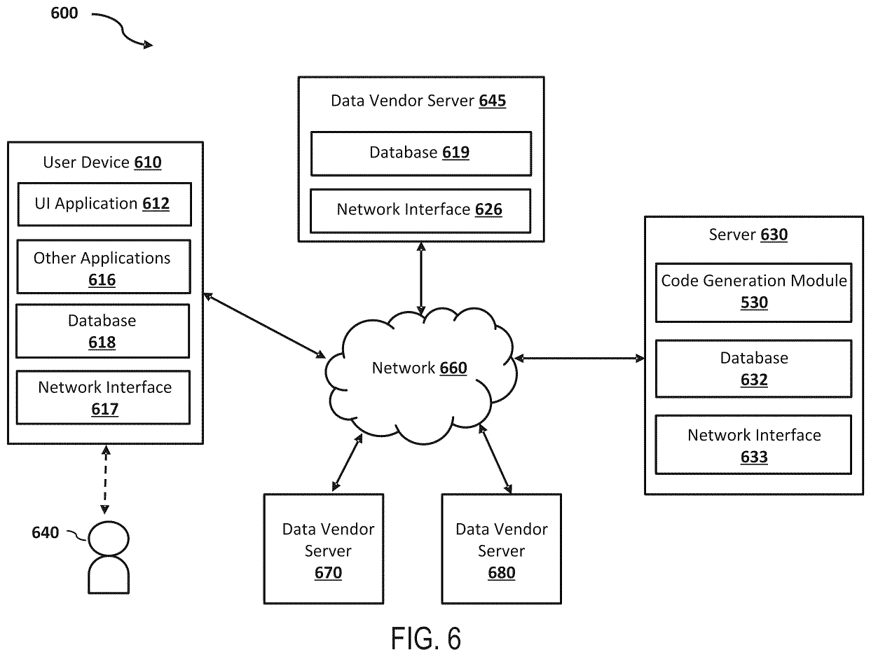

FIG. 6 is a simplified block diagram of a networked system 600 suitable for implementing the code generation framework described in FIGS. 1-5B and other embodiments described herein. In one embodiment, system 600 includes the user device 610 which may be operated by user 640, data vendor servers 645, 670 and 680, server 630, and other forms of devices, servers, and/or software components that operate to perform various methodologies in accordance with the described embodiments. Exemplary devices and servers may include device, stand-alone, and enterprise-class servers which may be similar to the computing device 300 described in FIG. 3A, operating an OS such as a MICROSOFT® OS, a UNIX® OS, a LINUX® OS, or other suitable device and/or server-based OS. It can be appreciated that the devices and/or servers illustrated in FIG. 6 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 610, data vendor servers 645, 670 and 680, and the server 630 may communicate with each other over a network 660. User device 610 may be utilized by a user 640 (e.g., a driver, a system admin, etc.) to access the various features available for user device 610, which may include processes and/or applications associated with the server 630 to receive an output data anomaly report.

User device 610, data vendor server 645, and the server 630 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 600, and/or accessible over network 660.

User device 610 may be implemented as a communication device that may utilize appropriate hardware and software configured for wired and/or wireless communication with data vendor server 645 and/or the server 630. For example, in one embodiment, user device 610 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 610 of FIG. 6 contains a user interface (UI) application 612, and/or other applications 616, which may correspond to executable processes, procedures, and/or applications with associated hardware. For example, the user device 610 may receive a message indicating generated text from the server 630 and display the message via the UI application 612. In other embodiments, user device 610 may include additional or different modules having specialized hardware and/or software as required.

In one embodiment, UI application 612 may communicatively and interactively generate a UI for an AI agent implemented through the code generation module 530 (e.g., an LLM agent) at server 630. In at least one embodiment, a user operating user device 610 may enter a user utterance, e.g., via text or audio input, such as a question, uploading a document, and/or the like via the UI application 612. Such user utterance may be sent to server 630, at which code generation module 530 may generate a response via the process described in FIGS. 1-5B. The code generation module 530 may thus cause a display of generated code at UI application 612 and interactively update the display in real time with the user utterance.

In various embodiments, user device 610 includes other applications 616 as may be desired in particular embodiments to provide features to user device 610. For example, other applications 616 may include security applications for implementing client-side security features, programmatic client applications for interfacing with appropriate application programming interfaces (APIs) over network 660, or other types of applications. Other applications 616 may also include communication applications, such as email, texting, voice, social networking, and IM applications that allow a user to send and receive emails, calls, texts, and other notifications through network 660. For example, the other application 616 may be an email or instant messaging application that receives a prediction result message from the server 630. Other applications 616 may include device interfaces and other display modules that may receive input and/or output information. For example, other applications 616 may contain software programs for asset management, executable by a processor, including a graphical user interface (GUI) configured to provide an interface to the user 640 to view generated text.

User device 610 may further include database 618 stored in a transitory and/or non-transitory memory of user device 610, which may store various applications and data and be utilized during execution of various modules of user device 610. Database 618 may store user profile relating to the user 640, predictions previously viewed or saved by the user 640, historical data received from the server 630, and/or the like. In some embodiments, database 618 may be local to user device 610. However, in other embodiments, database 618 may be external to user device 610 and accessible by user device 610, including cloud storage systems and/or databases that are accessible over network 660.

User device 610 includes at least one network interface component 617 adapted to communicate with data vendor server 645 and/or the server 630. In various embodiments, network interface component 617 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 645 may correspond to a server that hosts database 619 to provide training datasets including generated code and user selections to the server 630. The database 619 may be implemented by one or more relational database, distributed databases, cloud databases, and/or the like.

The data vendor server 645 includes at least one network interface component 626 adapted to communicate with user device 610 and/or the server 630. In various embodiments, network interface component 626 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 645 may send asset information from the database 619, via the network interface 626, to the server 630.

The server 630 may be housed with the code generation module 530 and its submodules described in FIG. 5A. In some implementations, code generation module 530 may receive data from database 619 at the data vendor server 645 via the network 660 to generate code. The generated code may also be sent to the user device 610 for review by the user 640 via the network 660.

The database 632 may be stored in a transitory and/or non-transitory memory of the server 630. In one implementation, the database 632 may store data obtained from the data vendor server 645. In one implementation, the database 632 may store parameters of the code generation module 530. In one implementation, the database 632 may store previously generated code, and the corresponding input feature vectors.

In some embodiments, database 632 may be local to the server 630. However, in other embodiments, database 632 may be external to the server 630 and accessible by the server 630, including cloud storage systems and/or databases that are accessible over network 660.

The server 630 includes at least one network interface component 633 adapted to communicate with user device 610 and/or data vendor servers 645, 670 or 680 over network 660. In various embodiments, network interface component 633 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 660 may be implemented as a single network or a combination of multiple networks. For example, in various embodiments, network 660 may include the Internet or one or more intranets, landline networks, wireless networks, and/or other appropriate types of networks. Thus, network 660 may correspond to small scale communication networks, such as a private or local area network, or a larger scale network, such as a wide area network or the Internet, accessible by the various components of system 600.

### Example Work Flows

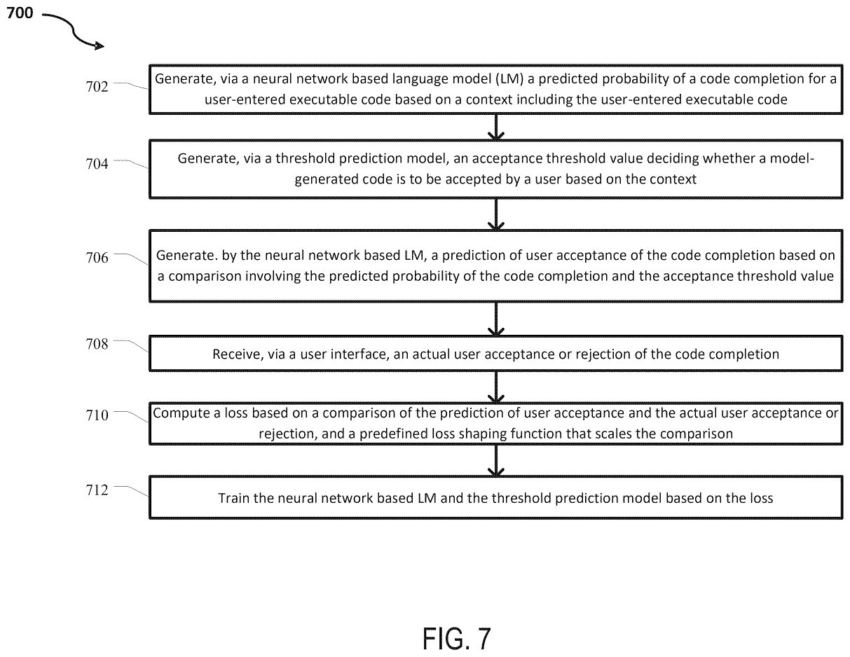

FIG. 7 is an example logic flow diagram illustrating a method of training a neural network based language model based on the framework shown in FIGS. 1-6, according to some embodiments described herein. One or more of the processes of method 700 may be implemented, at least in part, in the form of executable code stored on non-transitory, tangible, machine-readable media that when run by one or more processors may cause the one or more processors to perform one or more of the processes. In some embodiments, method 700 corresponds to the operation of the code generation module 530 (e.g., FIGS. 5A-6) that performs training and inference of a code generation model (e.g., a neural network based language model).

As illustrated, the method 700 includes a number of enumerated steps, but aspects of the method 700 may include additional steps before, after, and in between the enumerated steps. In some aspects, one or more of the enumerated steps may be omitted or performed in a different order.

At step 702, a system (e.g., computing device 500, user device 610, or server 630) generates, via a neural network based LM (e.g., language model 256), a predicted probability of a code completion for a user-entered executable code based on a context including the user-entered executable code. The predicted probability may be utilized by the system in displaying predicted text with the highest probability. In some embodiments, randomness in the generated code may be introduced by using a non-zero temperature value such that the generated text is selected with some randomness from among the text that is higher probability (e.g., a higher temperature is more likely to select less probable text output). In some embodiments, the context further includes a user prompt describing a desired outcome of the user-entered executable code.

At step 704, the system generates, via a threshold prediction model, an acceptance threshold value deciding whether a model-generated code is to be accepted by a user based on the context. In some embodiments, the threshold prediction model is trained specifically for each user. In some embodiments, an indication of which user is using the system is prepended to the context such that the threshold prediction model may adjust its output based on the current user. In some embodiments, when it is an unknown user, a threshold prediction model with defaults parameters may be utilized. In some embodiments, the threshold prediction model with default parameters may be updated as the user interacts with the system as described herein.

At step 706, the system generates, by the neural network based LM, a prediction of user acceptance of the code completion based on a comparison involving the predicted probability of the code completion and the acceptance threshold value. In some embodiments, the prediction of user acceptance is further based on a probability of the predicted output text of a baseline LM based on the context.

At step 708, the system receives, via a user interface (e.g., data interface 515, UI application 612, network interface 617, or network interface 633), an actual user acceptance or rejection of the code completion.

At step 710, the system computes a loss based on a comparison of the prediction of user acceptance and the actual user acceptance or rejection, and a predefined loss shaping function that scales the comparison. In some embodiments, computing the loss includes using the prediction of user acceptance as the loss based on the actual user acceptance or rejection being an acceptance. In some embodiments, computing the loss includes using the prediction of user acceptance subtracted from one as the loss based on the actual user acceptance or rejection being a rejection. In some embodiments, the predefined loss shaping function provides a scaling value that decreases linearly with a loss value when the loss value belongs to a first range. In some embodiments, the predefined loss shaping function provides a scaling value that decreases at a greater rate than the first range when the loss value belongs to a second range that is greater than the first range. In some embodiments, the loss is computed according to equation (7). In some embodiments, the loss shaping function is as illustrated, or substantially as illustrated, in FIG. 3.

At step 712, the system trains the neural network based LM and the threshold prediction model based on the loss. In some embodiments the system generates, via the LM after updating parameters, an auto-complete prediction text based on a second context.

In one embodiment, method 700 is applicable in a variety of applications. For example, the task request received by the neural network model may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 700, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 700 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

### Example Results

FIGS. 8-11 provide charts illustrating exemplary performance of different embodiments described herein.

FIG. 8 illustrates a comparison of performance with and without the use of a user ID (e.g., user ID 266). As illustrated, as training occurs, the accuracy improves for both cases, however the use of a User ID improves the performance over time.

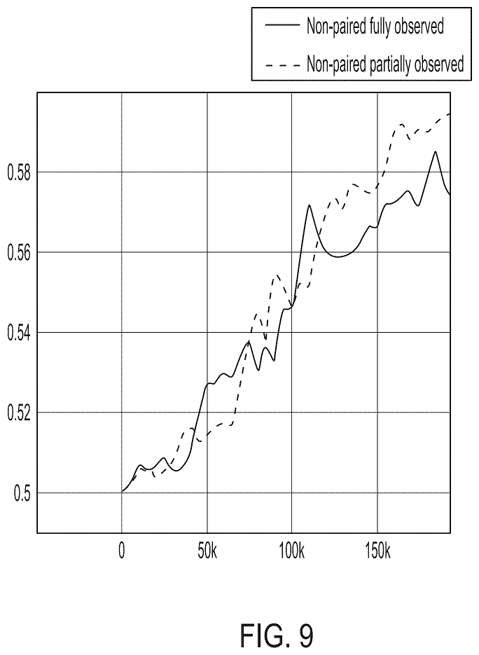

FIG. 9 illustrates a learning curve of accuracy on a held out dataset during training. The chart illustrates a comparison of non-paired fully observed data to non-paired partially observed data. As illustrated, similar or even better performance may be achieved with non-paired partially observed data utilizing methods described herein.

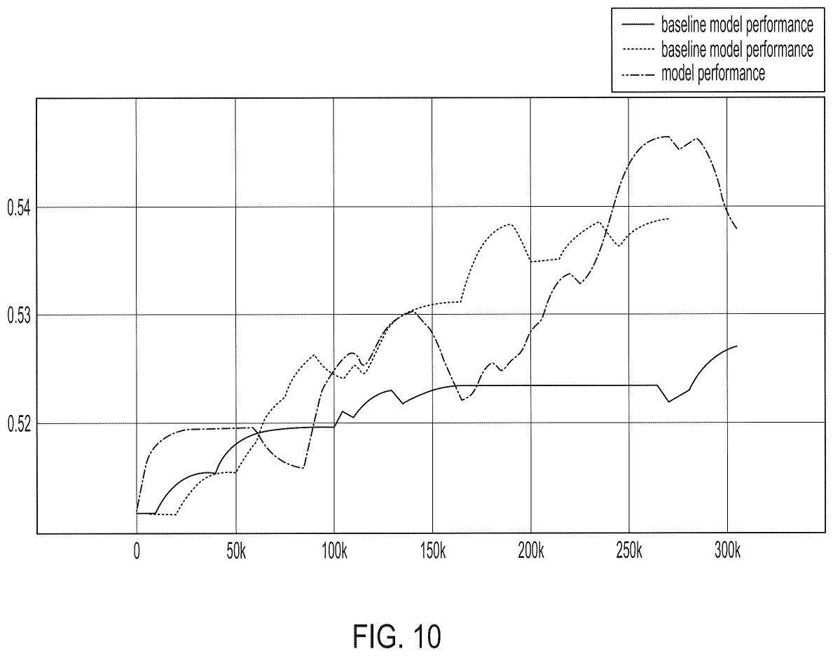

FIG. 10 illustrates the learning curve of accuracy on the Helpful and Harmless (HH) dataset as described in Bai et al., Training a helpful and harmless assistant with reinforcement learning from human feedback, arXiv:2204.05862, 2022. As illustrated, after full training, the method described herein performed better than the two baselines. Baselines tested included ULMA and NCA. ULMA is described in Cai et al., ULMA: Unified Language Model Alignment with Demonstration and Point-wise Human Preference, arXiv:2312.02554, 2023. NCA is described in Chen et al., Noise contrastive alignment of language models with explicit rewards, arXiv:2402.05369, 2024.

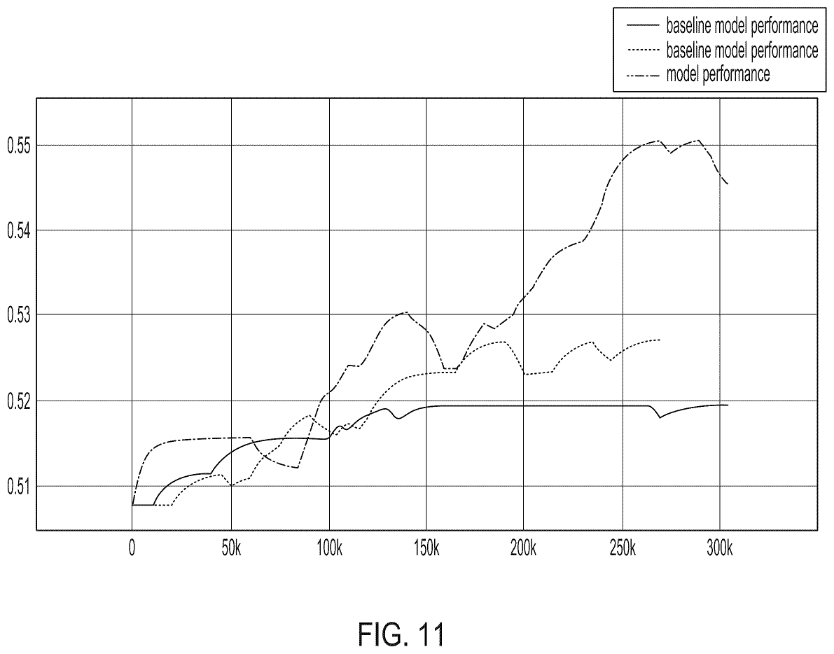

FIG. 11 illustrates the learning curve of accuracy on the Helpful and Harmless (HH) dataset. In addition to the HH test-set, a fine grained test was generated using HH Red-team data. The HH Red-team dataset contains only data instances that are accepted as helpful and harmless. Each data instance in this dataset has a labeler's score. The data instances were grouped by labelers and prompt. Within each of this grouping, data instances were constructed using a pair of responses and were assigned labels based on their relative labeler's score. A perplexity based win-rate was used as the measure for evaluation. As illustrated, after full training, the method described herein performed better than the baselines of ULMA and NCA for this fine grained test.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for training a neural network based language model (LM) for code generation, comprising:
generating, via the neural network based LM, a predicted probability of a code completion for a user-entered executable code based on a context including the user-entered executable code;
generating, via a threshold prediction model, an acceptance threshold value deciding whether a model-generated code is to be accepted by a user based on the context;
generating, by the neural network based LM, a prediction of user acceptance of the code completion based on a comparison involving the predicted probability of the code completion and the acceptance threshold value;
receiving, via a user interface, an actual user acceptance or rejection of the code completion;
computing a loss based on a comparison of the prediction of user acceptance and the actual user acceptance or rejection, and a predefined loss shaping function that scales the comparison; and
training the neural network based LM and the threshold prediction model based on the loss.

2. The method of claim 1, further comprising generating, via the LM after updating parameters, an auto-complete prediction text based on a second context.

3. The method of claim 1, wherein the generating a prediction of user acceptance is further based on a probability of the predicted output text of a baseline LM based on the context.

4. The method of claim 1, wherein computing the loss includes using the prediction of user acceptance as the loss based on the actual user acceptance or rejection being an acceptance.

5. The method of claim 1, wherein computing the loss includes using the prediction of user acceptance subtracted from one as the loss based on the actual user acceptance or rejection being a rejection.

6. The method of claim 1, wherein the predefined loss shaping function provides a scaling value that decreases linearly with a loss value when the loss value belongs to a first range.

7. The method of claim 6, wherein the predefined loss shaping function provides a scaling value that decreases at a greater rate than the first range when the loss value belongs to a second range that is greater than the first range.

8. The method of claim 1, wherein the context further includes a user prompt describing a desired outcome of the user-entered executable code.

9. A system for training a neural network based language model (LM) for code generation, the system comprising:
a memory that stores the neural network based language LM and a plurality of processor executable instructions; and
one or more hardware processors that read and execute the plurality of processor-executable instructions from the memory to perform operations comprising:
generating, via the neural network based LM, a predicted probability of a code completion for a user-entered executable code based on a context including the user-entered executable code;
generating, via a threshold prediction model, an acceptance threshold value deciding whether a model-generated code is to be accepted by a user based on the context;
generating, by the neural network based LM, a prediction of user acceptance of the code completion based on a comparison involving the predicted probability of the code completion and the acceptance threshold value;
receiving, via a user interface, an actual user acceptance or rejection of the code completion;
computing a loss based on a comparison of the prediction of user acceptance and the actual user acceptance or rejection, and a predefined loss shaping function that scales the comparison; and
training the neural network based LM and the threshold prediction model based on the loss.

10. The system of claim 9, further comprising generating, via the LM after updating parameters, an auto-complete prediction text based on a second context.

11. The system of claim 9, wherein the generating a prediction of user acceptance is further based on a probability of the predicted output text of a baseline LM based on the context.

12. The system of claim 9, wherein computing the loss includes using the prediction of user acceptance as the loss based on the actual user acceptance or rejection being an acceptance.

13. The system of claim 9, wherein computing the loss includes using the prediction of user acceptance subtracted from one as the loss based on the actual user acceptance or rejection being a rejection.

14. The system of claim 9, wherein the predefined loss shaping function provides a scaling value that decreases linearly with a loss value when the loss value belongs to a first range.

15. The system of claim 14, wherein the predefined loss shaping function provides a scaling value that decreases at a greater rate than the first range when the loss value belongs to a second range that is greater than the first range.

16. The system of claim 9, wherein the context further includes a user prompt describing a desired outcome of the user-entered executable code.

17. A non-transitory machine-readable medium comprising a plurality of machine-executable instructions which, when executed by one or more processors, are adapted to cause the one or more processors to perform operations comprising:
generating, via a neural network based language model (LM), a predicted probability of a code completion for a user-entered executable code based on a context including the user-entered executable code;
generating, via a threshold prediction model, an acceptance threshold value deciding whether a model-generated code is to be accepted by a user based on the context;
generating, by the neural network based LM, a prediction of user acceptance of the code completion based on a comparison involving the predicted probability of the code completion and the acceptance threshold value;
receiving, via a user interface, an actual user acceptance or rejection of the code completion;
computing a loss based on a comparison of the prediction of user acceptance and the actual user acceptance or rejection, and a predefined loss shaping function that scales the comparison; and
training the neural network based LM and the threshold prediction model based on the loss.

18. The non-transitory machine-readable medium of claim 17, further comprising generating, via the LM after updating parameters, an auto-complete prediction text based on a second context.

19. The non-transitory machine-readable medium of claim 17, wherein the generating a prediction of user acceptance is further based on a probability of the predicted output text of a baseline LM based on the context.

20. The non-transitory machine-readable medium of claim 17, wherein computing the loss includes using the prediction of user acceptance as the loss based on the actual user acceptance or rejection being an acceptance.
